(19) United States
(12) Patent Application Publication
(10) Pub. No.: US 2007/0008526 A1
(43) Pub. Date: Jan. 11, 2007

(54) Apparatus and method for non-contact assessment of a constituent in semiconductor workpieces

(76) Inventor: Andrzej Buczkowski, Bend, OR (US)

Correspondence Address: PERKINS COIE LLP;PATENT-SEA, P.O. BOX 1247, SEATTLE, WA, 98111-1247, US

(21) Appl. No.: 11/177,735

(22) Filed: Jul. 8, 2005

(51) Int. Cl. G01J 3/30

(52) U.S. Cl. 356/318

(57) ABSTRACT

Methods and apparatus for assessing a constituent in a semiconductor workpiece are disclosed herein. Several embodiments of the invention are directed toward non-contact methods and systems for determining a dose and an implant energy of a dopant or other constituent implanted in a semiconductor workpiece. For example, one embodiment of a non-contact method for assessing a constituent in a semiconductor workpiece includes irradiating a portion of the semiconductor workpiece, measuring photoluminescence from the irradiated portion of the semiconductor workpiece, and determining a physical property of a doped structure in the semiconductor workpiece based on the measured photoluminescence.

### TECHNICAL FIELD

The present invention generally relates to non-contact methods and apparatus for assessing constituents in semiconductor wafers. For example, several embodiments of the invention are related to non-contact methods and apparatus for determining the concentration and energy of a doped structure in a semiconductor wafer.

### BACKGROUND

Microelectronic devices are manufactured on silicon wafers, gallium arsenide wafers, and other types of semiconductor wafers. The semiconductor wafers generally have discrete regions where specific types of atoms have been implanted to impart the desired electrical properties to the wafer. A typical ion implantation procedure involves constructing a pattern across the surface of the wafer using photolithography processes, ionizing dopant atoms, and accelerating the ions toward the semiconductor wafer such that the ions strike and penetrate the exposed portions of the wafer. Implanting a precise concentration of atoms at a desired depth in the wafer is necessary to impart the desired electrical properties to the discrete regions of the wafer. If the concentration of atoms or the depth of the atoms is outside the specification, the region may not have the required conductivity and consequently the wafer may be defective. Identifying defective wafers after ion implantation is desirable so that the wafers are not subject to additional expensive processing procedures.

One conventional method for measuring the concentration and location of implanted ions includes directing light toward the wafer and measuring the phase shift, intensity, and other properties of the reflected light. This method, however, is limited by the wavelength of the light. As a result, as features on semiconductor wafers become smaller, this method produces less accurate results. Accordingly, there is a need to improve the process of measuring the concentration and depth of implanted ions.

### SUMMARY

The present invention is directed toward methods and apparatus for assessing a constituent in a semiconductor workpiece. Several embodiments of the invention are directed toward non-contact methods and systems for determining a physical property of a doped structure in a semiconductor workpiece. For example, one embodiment of a non-contact method for assessing a constituent in a semiconductor workpiece includes irradiating a portion of the semiconductor workpiece, measuring photoluminescence from the irradiated portion of the semiconductor workpiece, and determining a physical property of a doped structure in the semiconductor workpiece based on the measured photoluminescence.

Another embodiment of a method for assessing a doped structure in a semiconductor workpiece includes measuring photoluminescence from a portion of the semiconductor workpiece having an implanted constituent, and estimating a dose and/or implant energy of the constituent based on a predetermined relationship between (a) photoluminescence and (b) dose and implant energy. The method can further include comparing the estimated dose and implant energy of the constituent with a predetermined range of acceptable dose and implant energy values for the specific constituent.

Another embodiment of a method for assessing a doped structure in a semiconductor workpiece includes measuring photoluminescence from the semiconductor workpiece and comparing the measured photoluminescence to a predetermined range of photoluminescence values that correspond to acceptable dose and implant energy values for a specific dopant. The method can further include directing a laser beam toward a portion of the semiconductor workpiece to effect the photoluminescence.

Another embodiment of a method for assessing a doped structure in a semiconductor workpiece includes irradiating a portion of a semiconductor workpiece with radiation at a first wavelength, measuring photoluminescence from the semiconductor workpiece resulting from the radiation at the first wavelength, irradiating the portion of the semiconductor workpiece with radiation at a second wavelength, and measuring photoluminescence from the semiconductor workpiece resulting from the radiation at the second wavelength. The second wavelength is different than the first wavelength. The method further includes estimating a physical property of a doped structure in the semiconductor workpiece by comparing the photoluminescence resulting from the radiation at the first wavelength and the photoluminescence resulting from the radiation at the second wavelength.

Another embodiment of a method for assessing a doped structure in a semiconductor workpiece includes irradiating a portion of a semiconductor workpiece, measuring photoluminescence from the irradiated portion of the semiconductor workpiece, and determining a status of the crystal structure in the irradiated portion of the semiconductor workpiece based on the measured photoluminescence. The method can further include annealing the workpiece for a period of time based on the determined status of the crystal structure.

Another aspect of the invention is directed toward apparatus for assessing a doped structure in a semiconductor workpiece. In one embodiment, an apparatus includes a laser configured to direct a laser beam toward a semiconductor workpiece, a detector configured to measure photoluminescence from the semiconductor workpiece, and a controller operably coupled to the detector. The controller has a computer-readable medium containing instructions to perform any one of the above-described methods.

### BRIEF DESCRIPTION OF THE DRAWINGS

FIG. 1 is a schematic illustration of an apparatus for assessing a doped structure in a semiconductor wafer.

FIG. 2 is an enlarged schematic side cross-sectional view of a portion of the wafer with a laser beam impinging upon an excited region of the wafer.

FIG. 3 is a schematic top plan view of the semiconductor wafer illustrating a doped region.

FIG. 4 is a flow chart illustrating one embodiment of a non-contact assessment method for assessing a doped structure in a semiconductor wafer in accordance with the invention.

FIG. 5 is a graph illustrating the correspondence between the photoluminescence and the dose and implant energy for one specific dopant.

FIG. 6 is a flow chart illustrating another embodiment of a non-contact assessment method for assessing a doped structure in a semiconductor wafer in accordance with the invention.

FIG. 7 is a flow chart illustrating another embodiment of a non-contact assessment method for assessing a doped structure in a semiconductor wafer in accordance with the invention.

FIG. 8 is an enlarged schematic side cross-sectional view of a portion of a wafer with a laser beam impinging upon an excited region of the wafer.

### DETAILED DESCRIPTION

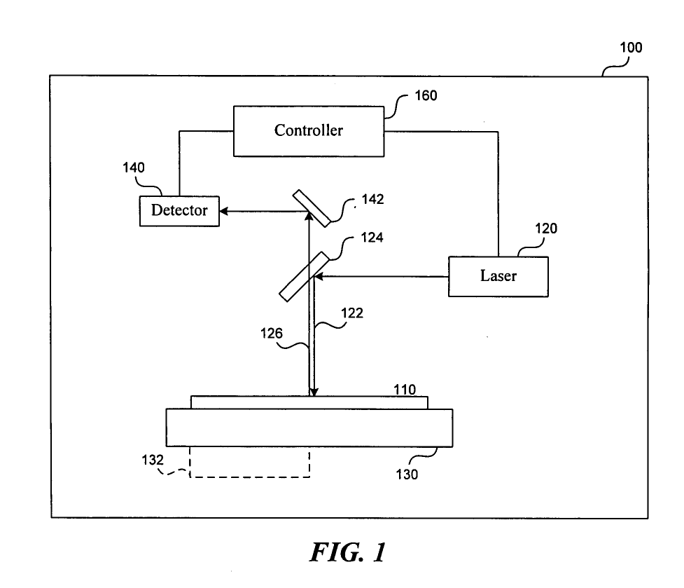

The following disclosure describes non-contact methods and apparatus for assessing doped structures in semiconductor wafers. Certain details are set forth in the following description and in FIGS. 1-8 to provide a thorough understanding of various embodiments of the invention. Other details describing well-known structures and systems often associated with processing semiconductor wafers are not set forth in the following disclosure to avoid unnecessarily obscuring the description of various embodiments of the invention. Many of the details, dimensions, angles, and other features shown in the figures are merely illustrative of particular embodiments of the invention. Accordingly, other embodiments can have other details, dimensions, and/or features without departing from the present invention. In addition, further embodiments of the invention may be practiced without several of the details described below, or various aspects of any of the embodiments described below can be combined in different embodiments. Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of items in the list. The term “comprising” is used throughout to mean including at least the recited feature(s) such that any greater number of the same feature and/or types of other features or components are not precluded. Additionally, the term “wafer” is defined as any substrate either by itself or in combination with additional materials that have been implanted in or otherwise deposited over the substrate.

### A. Embodiments of an Apparatus for Assessing a Doped Structure in a Semiconductor Wafer

FIG. 1 is a schematic illustration of an apparatus 100 for assessing a doped structure in a semiconductor wafer 110. The apparatus 100 assesses physical properties of the doped structure by exciting a population of the atoms in a portion of the semiconductor wafer 110 and measuring the photoluminescence from the excited atoms. Based on the measured photoluminescence, the apparatus 100 can determine the concentration of ions in the portion of the wafer 110, the effective energy imparted to the wafer 110 during ion implantation, and/or other characteristics of the doped structure. The apparatus 100 can be a freestanding system separate from a workpiece processing tool, or the apparatus 100 can be a component of an ion implantor or other processing tool that performs a process on the wafer 110.

In the illustrated embodiment, the apparatus 100 includes a laser 120 for producing a laser beam 122 to impinge upon a portion of the wafer 110 and effect photoluminescence 126 from the portion of the wafer 110, a detector 140 for measuring the photoluminescence 126 from the wafer 110, and a controller 160 for operating the laser 120 and the detector 140. The laser 120 is configured to produce a laser beam with a selected wavelength to penetrate the wafer 110 to a desired depth. In several applications, the laser 120 may adjust the wavelength of the laser beam 122 to penetrate different depths of the wafer 110 and effect photoluminescence 126 from different regions of the wafer 110. In other applications, however, the laser 120 may not adjust the wavelength of the laser beam 122. Moreover, in additional embodiments, the apparatus 100 may include multiple lasers that each produce a laser beam with a different wavelength. The detector 140 can include a lens, filter, and/or other mechanism to isolate certain wavelengths of the photoluminescence 126 and measure the photoluminescence 126 from a selected doped structure on the wafer 110.

The illustrated apparatus 100 further includes a beam controller 124 for directing the laser beam 122 toward one or more desired regions of the wafer 110 and a reflector 142 for directing at least some of the photoluminescence 126 from the wafer 110 to the detector 140. The beam controller 124 can include optical fibers, a beam expander, a beam splitter, and/or other devices to direct the laser beam 122. The apparatus 100 may also include a support member 130 for carrying the wafer 110 and a positioning device 132 (shown in hidden lines) for moving the support member 130 to accurately and properly position the wafer 110 relative to the laser 120 and/or beam controller 124. Suitable apparatuses are described in PCT application No. WO 98/114, which is hereby incorporated by reference, and include the SiPHER tool manufactured by Accent Optical Technologies of Bend, Oreg. In other embodiments, the apparatus 100 may not include the beam controller 124 and/or the reflector 142. In additional embodiments, the apparatus 100 may not include a laser 120, but rather has a different mechanism for producing high intensity light to effect photoluminescence from the wafer 110.

The apparatus 100 effects photoluminescence 126 from the wafer 110 and measures the photoluminescence 126 to assess a doped structure on the wafer 110. For example, the measured photoluminescence can be (a) used to calculate the dose and implant energy of the implanted constituent, and/or (b) compared to a predetermined range of photoluminescence values that are based on acceptable dose and implant energy values. As such, based on the measured photoluminescence, the apparatus 100 can determine whether the doped structure on the wafer 110 is within specification and/or whether processing variables, such as the ion implantation parameters, should be changed.

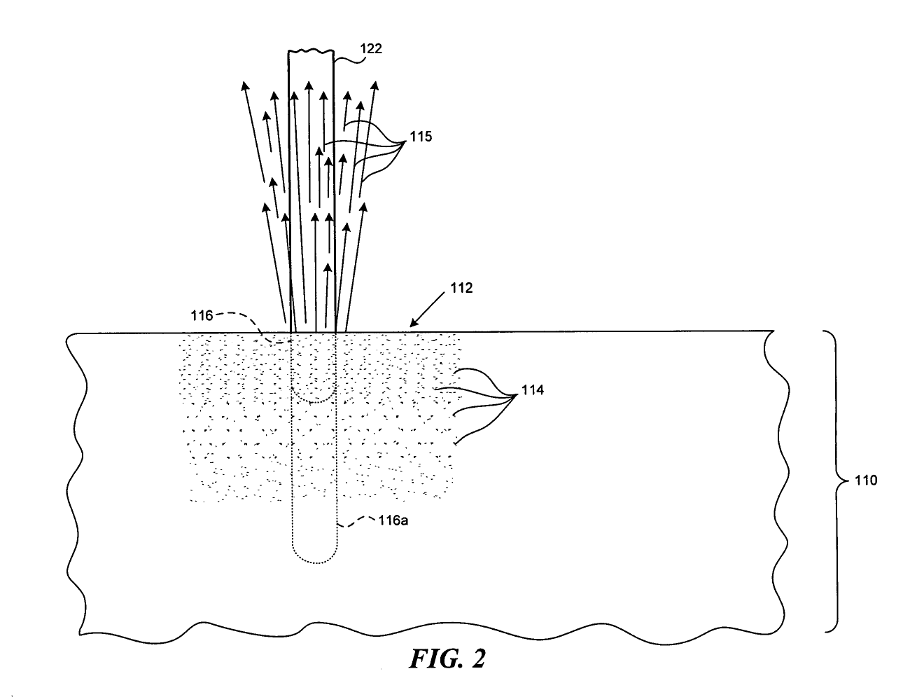

FIG. 2 is an enlarged schematic side cross-sectional view of a portion of the wafer 110 with the laser beam 122 impinging upon an excited region 116 of the wafer 110. The illustrated wafer 110 includes a doped portion 112 with a plurality of implanted ions 114. The ions 114 can be introduced into the wafer 110 via ion implantation, diffusion, or other suitable processes. The laser beam 122 excites the excited region 116 of the wafer 110 such that electrons in the wafer 110 move from the valence band to the conductance band. When the electrons recombine (i.e., move back from the conductance band to the valence band), the electrons release energy by emitting photoluminescence in a process called radiative recombination. The electrons may also recombine without emitting photoluminescence in a process called non-radiative recombination. The implanted ions 114 affect the balance between radiative and non-radiative recombination. Specifically, the implanted ions 114 increase non-radiative recombination and reduce photoluminescence because the crystal structure of the wafer 110 is damaged by colliding ions during implantation and the defects in the crystal structure enhance non-radiative recombination. Thus, the photoluminescence produced by the excited region 116 of the wafer 110 is a function of (a) the dose or concentration of ions 114 in the doped portion 112, and (b) the effective energy imparted to the wafer 110 during ion implantation. For purposes of brevity, the effective energy imparted to the wafer 110 during ion implantation will be referred to below as the implant energy. In other embodiments, the laser beam 122 may impinge upon an excited region 116a of the wafer 110 that extends below the doped portion 112.

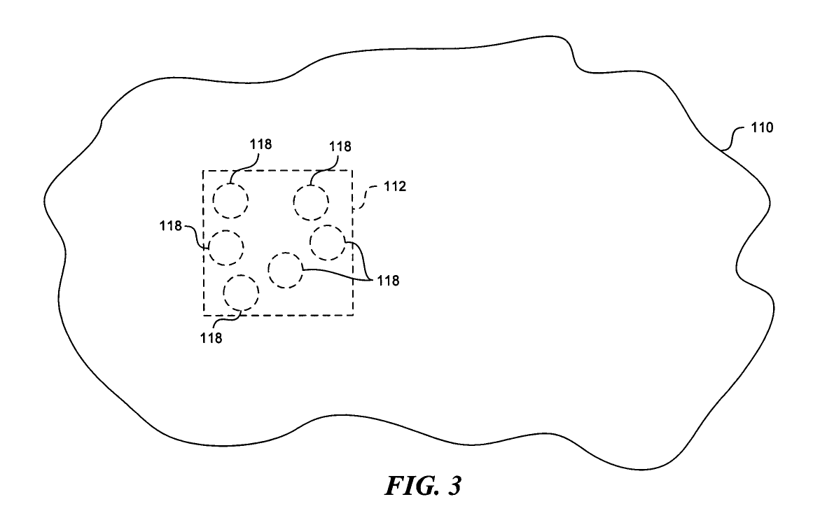

FIG. 3 is a schematic top plan view of the semiconductor wafer 110 illustrating the doped portion 112. Referring to FIGS. 1 and 3, in several applications, the apparatus 100 effects and measures the photoluminescence from several sections within a single region of a wafer, and then averages the measured values to calculate a single photoluminescence value for the entire region. This approach advantageously reduces the error due to signal noise and other measurement anomalies. For example, the apparatus 100 can measure the photoluminescence from a plurality of sections 118 in a single doped portion 112. The photoluminescence values of the different sections 118 can be averaged to form a single photoluminescence value for the entire doped portion 112. In other embodiments, the apparatus 100 may not average the photoluminescence values of all of the different sections 118, or the apparatus 100 may measure the photoluminescence value of only a single section 118 within the doped portion 112. In additional embodiments, the apparatus 100 can measure the photoluminescence from a single section of a wafer several times, and then average the measured values to calculate a single photoluminescence value for the section.

### B. Embodiments of Methods for Assessing a Doped Structure in a Semiconductor Wafer

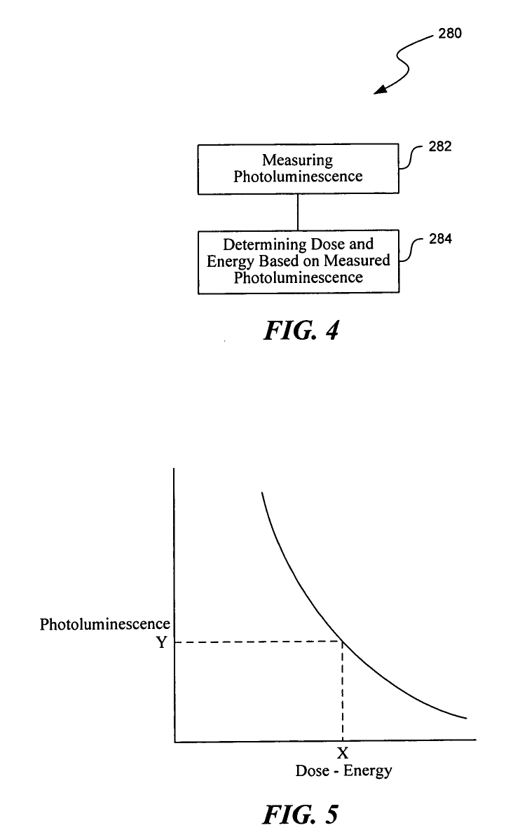

FIG. 4 is a flow chart illustrating one embodiment of a non-contact assessment method 280 for assessing a doped structure in a semiconductor wafer in accordance with the invention. The assessment method 280 is particularly well suited for determining the dose and the implant energy of ions implanted in a doped region of a wafer. The method 280 includes a photoluminescence procedure 282 and an evaluation procedure 284. Referring to FIGS. 1 and 4, the photoluminescence procedure 282 includes irradiating a doped portion of the wafer 110 with the laser beam 122 and measuring the photoluminescence 126 from the wafer 110. The evaluation procedure 284 includes determining the dose and/or implant energy of the atoms in the doped portion of the wafer 110 based on the measured photoluminescence. In several applications, the controller 160 includes a computer-readable medium containing data regarding the relationship between (a) a measured photoluminescence, and (b) the dose and implant energy of a specific dopant. For example, FIG. 5 is a graph illustrating the correspondence between the photoluminescence and the dose and implant energy for one specific dopant. If the detector 140 measures a photoluminescence value of Y from the doped portion of the wafer 110, the controller 160 can determine that the doped portion of the wafer 110 has a dose and implant energy value of X. The relationship between photoluminescence and dose and implant energy is dopant specific, and therefore, the computer-readable medium may include data for numerous different dopants. Moreover, the data may correspond to a single implantation of atoms and/or a sequence of implantations.

The database of photoluminescence values for specific dose and implant energy values can be built by measuring the photoluminescence of portions of semiconductor wafers having known dose and implant energy values. The dose and implant energy values of these wafers can be determined by any one of the methods described above in the Background section and/or via destructive testing methods, such as cutting a wafer and measuring the dose and/or implant energy of the dopant in the wafer. After obtaining sufficient data points for each dopant, statistical methods, such as interpolation, extrapolation, and/or optimization, can be used to complete the data base.

One feature of the method illustrated in FIGS. 1-5 is that the apparatus 100 can accurately determine the dose and/or implant energy of a constituent implanted in a semiconductor wafer without having to measure the reflectance of light from the wafer and the properties of the reflected light. Rather, the apparatus 100 effects photoluminescence from the wafer and measures the photoluminescence. Consequently, the illustrated method can accurately measure properties of doped structures and other small features on a wafer.

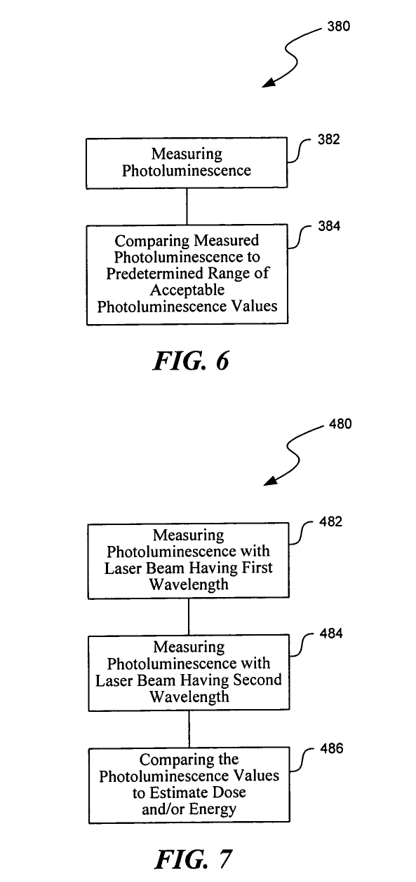

FIG. 6 is a flow chart illustrating another embodiment of a non-contact assessment method 380 for assessing a doped structure in a semiconductor wafer in accordance with the invention. The illustrated assessment method 380 includes a photoluminescence procedure 382 and a comparing procedure 384. The photoluminescence procedure 382 can be generally similar to the photoluminescence procedure 282 described above with reference to FIG. 4. The comparing procedure 384 includes comparing the measured photoluminescence to a predetermined range of acceptable photoluminescence values for the specific dopant. The predetermined range of acceptable photoluminescence values is calculated by ascertaining the photoluminescence values that correspond with acceptable values of dose and implant energy for the specific dopant. An advantage of this method is that the controller 160 (FIG. 1) need not calculate the specific dose and implant energy associated with each photoluminescence value, but rather need only compare the measured photoluminescence value to a predetermined range of acceptable values to determine whether the wafer is within specification. As such, this process provides a fast quality control test for eliminating dies or wafers from further processing at an early stage.

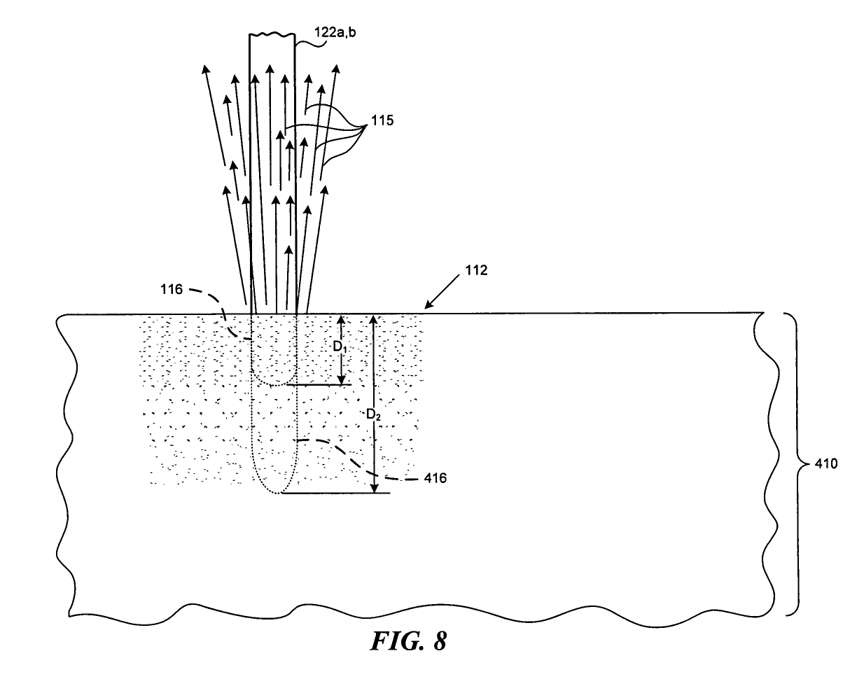

FIG. 7 is a flow chart illustrating another embodiment of a non-contact assessment method 480 for assessing a doped structure in a semiconductor wafer in accordance with the invention. The illustrated assessment method 480 includes a first photoluminescence procedure 482, a second photoluminescence procedure 484, and a comparing procedure 486. FIG. 8 is a schematic side cross-sectional view of a portion of a wafer 410 being processed in accordance with this method. Referring to both FIGS. 7 and 8, the first photoluminescence procedure 482 includes directing a first laser beam 122a having a first wavelength λ₁ toward the wafer 410 to excite a first excited region 116 such that the excited wafer 410 emits photons 115 and produces photoluminescence. The first excited region 116 has a first depth D₁ corresponding to the penetration of the first wavelength λ₁ of the first laser beam 122a. The first photoluminescence procedure 482 also includes measuring the photoluminescence produced by the first excited region 116.

The second photoluminescence procedure 484 includes directing a second laser beam 122b having a second wavelength λ₂ toward the wafer 410. The second laser beam 122b with the second wavelength λ₂ excites a second excited region 416 of the wafer 410 such that the excited wafer 410 emits photons 115 and produces photoluminescence. The second excited region 416 has a second depth D₂ greater than the first depth D₁ and corresponds to the penetration depth of the second wavelength λ₂ of the second laser beam 122b. As described above with reference to FIG. 2, in other embodiments, the penetration depth of the first and second laser beams 122a-b can extend beyond the doped region 112 of the wafer 410. In either case, the second photoluminescence procedure 484 also includes measuring the photoluminescence produced by the second excited region 416. The first and second photoluminescence procedures 482 and 484 may occur sequentially or concurrently. If the procedures 482 and 484 occur concurrently, the detector 140 can include a device for separating the photoluminescence effects from each of the laser beams 122a-b, which advantageously reduces the time required to take measurements.

The comparing procedure 486 includes comparing (a) the measured photoluminescence resulting from the first laser beam 122a at the first wavelength λ₁ and (b) the measured photoluminescence resulting from the second laser beam 122b at the second wavelength λ₂. The controller 160 can determine the dose and implant energy of the ions 114 implanted in the doped portion 112 of the wafer 410 based on the difference between these two measured values of photoluminescence because the second excited region 416 includes a lower concentration of implanted ions 114b and therefore produces different levels or signatures of photoluminescence. In other embodiments, more than two wavelengths of radiation can be used to excite different regions of the wafer to further enhance the implant energy data.

In additional embodiments, the apparatus 100 can assess a doped structure on a semiconductor wafer during post-implantation processing. For example, the apparatus 100 can measure the photoluminescence from a doped structure on a wafer during an anneal process to determine the state of the crystal structure. Specifically, in one embodiment, after annealing a wafer for a period time, the apparatus 100 can irradiate a doped portion of the wafer and measure the photoluminescence from the wafer. Based on the measured photoluminescence, the apparatus 100 can determine the state of the crystal structure in the wafer and whether further annealing is necessary. For example, the apparatus 100 can include a computer-readable medium containing data regarding the relationship between (a) a measured photoluminescence, and (b) the crystallinity of a doped structure. Alternatively, the computer-readable medium can compare the measured photoluminescence to a predetermined range of acceptable photoluminescence values for a suitably annealed doped structure. In other embodiments, the apparatus 100 can assess the doped structure during other post-implantation processes.

From the foregoing, it will be appreciated that specific embodiments of the invention have been described herein for purposes of illustration, but that various modifications may be made without deviating from the invention. For example, aspects of the invention described in the context of particular embodiments may be combined or eliminated in other embodiments. Accordingly, the invention is not limited except as by the appended claims.

I/We claim:

1. A non-contact method of assessing a doped structure in a semiconductor workpiece, comprising:
irradiating a portion of a semiconductor workpiece;
measuring photoluminescence from the irradiated portion of the semiconductor workpiece; and
determining a physical property of a doped structure in the semiconductor workpiece based on the measured photoluminescence.

2. The method of claim 1 wherein:
irradiating a portion of the semiconductor workpiece comprises (a) impinging a laser beam upon a first section of the portion of the workpiece, and (b) impinging the laser beam upon a second section of the portion of the workpiece, the second section being spaced apart from the first section;
measuring photoluminescence from the semiconductor workpiece comprises (a) ascertaining a first value of photoluminescence resulting from impinging the laser beam upon the first section of the workpiece, and (b) ascertaining a second value of photoluminescence resulting from impinging the laser beam upon the second section of the workpiece; and
determining the physical property of the doped structure comprises estimating a dose and an implant energy of a dopant based on the first and second values of photoluminescence.

3. The method of claim 1 wherein:
irradiating a portion of the semiconductor workpiece comprises (a) impinging a laser beam upon a first section of the portion of the workpiece, and (b) impinging the laser beam upon a second section of the portion of the workpiece, the second section at least partially overlapping the first section;
measuring photoluminescence from the semiconductor workpiece comprises (a) ascertaining a first value of photoluminescence resulting from impinging the laser beam upon the first section of the workpiece, and (b) ascertaining a second value of photoluminescence resulting from impinging the laser beam upon the second section of the workpiece; and
determining the physical property of the doped structure comprises estimating a dose and an implant energy of a dopant based on the first and second values of photoluminescence.

4. The method of claim 1 wherein determining the physical property of the doped structure comprises estimating a dose and an implant energy based on a predetermined relationship between (a) photoluminescence and (b) dose and implant energy.

5. The method of claim 1 wherein:
irradiating the semiconductor workpiece comprises (a) impinging a first laser beam with a first wavelength upon the semiconductor workpiece, and (b) impinging a second laser beam with a second wavelength upon the semiconductor workpiece;
measuring photoluminescence from the semiconductor workpiece comprises (a) ascertaining a first value of photoluminescence resulting from impinging the first laser beam upon the semiconductor workpiece, and (b) ascertaining a second value of photoluminescence resulting from impinging the second laser beam upon the semiconductor workpiece; and
determining the physical property of the doped structure comprises estimating a dose and an implant energy of a dopant based on the first and second values of photoluminescence.

6. The method of claim 1, further comprising comparing the determined physical property of the doped structure with a predetermined range of acceptable dose and implant energy values for a specific dopant.

7. The method of claim 1 wherein:
irradiating the semiconductor workpiece comprises impinging a laser beam upon a plurality of sections of the portion of the workpiece;
measuring photoluminescence from the semiconductor workpiece comprises (a) ascertaining values of photoluminescence resulting from impinging the laser beam upon the sections of the workpiece, and (b) averaging at least some of the values of photoluminescence; and
determining the physical property of the doped structure comprises estimating a dose and an implant energy based on the average of the at least some of the values of photoluminescence.

8. The method of claim 1 wherein determining the physical property of the structure comprises estimating a dose and an implant energy of a dopant without analyzing a reflectance of light from the semiconductor workpiece.

9. The method of claim 1 wherein determining the physical property of the doped structure comprises estimating a dose of a dopant implanted in the semiconductor workpiece.

10. The method of claim 1 wherein determining the physical property of the doped structure comprises estimating a concentration of atoms implanted in the semiconductor workpiece.

11. The method of claim 1 wherein determining the physical property of the doped structure comprises estimating an implant energy of a dopant implanted in the semiconductor workpiece.

12. The method of claim 1 wherein irradiating the semiconductor workpiece comprises directing a laser beam toward the portion of the workpiece.

13. The method of claim 1 wherein determining the physical property of the doped structure comprises estimating a status of the crystallinity of the doped structure.

14. A non-contact method of assessing a doped structure in a semiconductor workpiece, comprising:
measuring photoluminescence from a portion of a semiconductor workpiece having an implanted constituent; and
estimating a dose and an implant energy of the implanted constituent based on a predetermined relationship between (a) photoluminescence and (b) dose and implant energy.

15. The method of claim 14, further comprising directing a laser beam toward the portion of the semiconductor workpiece to effect the photoluminescence.

16. The method of claim 14, further comprising:
directing a laser beam toward a first section of the portion of the workpiece; and
directing the laser beam toward a second section of the portion of the workpiece, the second section being different than the first section;
wherein measuring photoluminescence from the semiconductor workpiece comprises (a) ascertaining a first value of photoluminescence resulting from directing the laser beam toward the first section of the workpiece, and (b) ascertaining a second value of photoluminescence resulting from directing the laser beam toward the second section of the workpiece; and
wherein estimating the dose and implant energy of the implanted constituent comprises determining the dose and implant energy based on the measured first and second values of photoluminescence.

17. The method of claim 14, further comprising:
directing a first laser beam with a first wavelength toward the portion of the workpiece; and
directing a second laser beam with a second wavelength toward the portion of the workpiece;
wherein measuring photoluminescence from the semiconductor workpiece comprises (a) ascertaining a first value of photoluminescence resulting from directing the first laser beam toward the workpiece, and (b) ascertaining a second value of photoluminescence resulting from directing the second laser beam toward the workpiece; and
wherein estimating the dose and implant energy of the implanted constituent comprises determining the dose and implant energy based on the measured first and second values of photoluminescence.

18. The method of claim 14, further comprising comparing the estimated dose and implant energy of the implanted constituent with a predetermined range of acceptable dose and implant energy values for the specific constituent.

19. The method of claim 14 wherein estimating the dose and implant energy of the implanted constituent comprises determining the dose and implant energy of the constituent without analyzing a reflectance of light from the semiconductor workpiece.

20. The method of claim 14, further comprising directing a laser beam toward a plurality of sections within the portion of the workpiece, wherein measuring photoluminescence from the semiconductor workpiece comprises (a) ascertaining values of photoluminescence resulting from directing the laser beam toward the sections of the workpiece, and (b) averaging at least some of the values of photoluminescence, and wherein estimating the dose and implant energy of the implanted constituent comprises determining the dose and implant energy based on the average of the at least some of the values of photoluminescence.

21. A non-contact method of assessing a doped structure in a semiconductor workpiece, comprising:
irradiating a portion of a semiconductor workpiece;
measuring photon intensity emitted from a portion of a semiconductor workpiece having the doped structure; and
determining a physical property of the doped structure in the semiconductor workpiece based on the measured photon intensity.

22. A non-contact method of assessing a doped structure in a semiconductor workpiece, comprising:
measuring photoluminescence from the semiconductor workpiece; and
comparing the measured photoluminescence to a predetermined range of photoluminescence values that correspond to acceptable dose and implant energy values for a specific dopant.

23. The method of claim 22, further comprising directing a laser beam toward a portion of the semiconductor workpiece to effect the photoluminescence.

24. The method of claim 22, further comprising estimating a dose and an implant energy of the dopant based on a predetermined relationship between (a) photoluminescence and (b) dose and implant energy.

25. The method of claim 22, further comprising:
directing a laser beam toward a first section of the workpiece; and
directing the laser beam toward a second section of the workpiece spaced apart from the first section;
wherein measuring photoluminescence from the semiconductor workpiece comprises (a) ascertaining a first value of photoluminescence resulting from directing the laser beam toward the first section of the workpiece, (b) ascertaining a second value of photoluminescence resulting from directing the laser beam toward the second section of the workpiece, and (c) calculating a third value of photoluminescence based on the first and second values of photoluminescence; and
wherein comparing the measured photoluminescence comprises comparing the third value of photoluminescence to the predetermined range of photoluminescence values.

26. The method of claim 22, further comprising:
directing a first laser beam with a first wavelength toward the workpiece; and
directing a second laser beam with a second wavelength toward the workpiece;
wherein measuring photoluminescence from the semiconductor workpiece comprises (a) ascertaining a first value of photoluminescence resulting from directing the first laser beam toward the workpiece, (b) ascertaining a second value of photoluminescence resulting from directing the second laser beam toward the workpiece, and (c) calculating a third value of photoluminescence based on the first and second values of photoluminescence; and
wherein comparing the measured photoluminescence comprises comparing the third value of photoluminescence to the predetermined range of photoluminescence values.

27. The method of claim 22, further comprising continuing to process the semiconductor workpiece if the measured photoluminescence is within the predetermined range.

28. The method of claim 22, further comprising discontinuing subsequent processing of the semiconductor workpiece if the measured photoluminescence is not within the predetermined range.

29. A non-contact method of assessing a doped structure in a semiconductor workpiece, comprising:
irradiating a portion of a semiconductor workpiece with radiation at a first wavelength;
measuring photoluminescence from the semiconductor workpiece resulting from the radiation at the first wavelength;
irradiating the portion of the semiconductor workpiece with radiation at a second wavelength, the second wavelength being different than the first wavelength;
measuring photoluminescence from the semiconductor workpiece resulting from the radiation at the second wavelength; and
estimating a physical property of a doped structure in the semiconductor workpiece by comparing the photoluminescence resulting from the radiation at the first wavelength and the photoluminescence resulting from the radiation at the second wavelength.

30. The method of claim 29 wherein:
irradiating the workpiece with radiation at the first wavelength comprises (a) impinging a first laser beam upon a first section of the workpiece, and (b) impinging the first laser beam upon a second section of the workpiece, the second section being different than the first section;
measuring photoluminescence from the semiconductor workpiece resulting from the radiation at the first wavelength comprises (a) ascertaining a first value of photoluminescence resulting from impinging the first laser beam upon the first section of the workpiece, and (b) ascertaining a second value of photoluminescence resulting from impinging the first laser beam upon the second section of the workpiece; and
estimating the physical property comprises determining a dose and/or implant energy of an implanted constituent based on the first and second values of photoluminescence.

31. The method of claim 29 wherein estimating the physical property comprises determining a dose and/or implant energy of a constituent based on a predetermined relationship between (a) photoluminescence and (b) dose and implant energy.

32. The method of claim 29, further comprising comparing the estimated physical property of the doped structure with a predetermined range of acceptable physical property values.

33. The method of claim 29 wherein:
irradiating the workpiece with radiation at the first wavelength comprises impinging a first laser beam upon a plurality of sections of the workpiece;
measuring photoluminescence from the semiconductor workpiece resulting from the first laser beam comprises (a) ascertaining values of photoluminescence resulting from impinging the first laser beam upon the sections of the workpiece, and (b) averaging at least some of the values of photoluminescence; and
estimating the physical property comprises determining a dose and/or implant energy based on the average of the at least some of the values of photoluminescence.

34. The method of claim 29 wherein irradiating the workpiece with the first wavelength occurs while irradiating the workpiece with the second wavelength.

35. The method of claim 29 wherein:
irradiating the workpiece with the first wavelength comprises impinging a first laser beam upon a first section of the workpiece; and
irradiating the workpiece with the second wavelength comprise impinging a second laser beam upon a second section of the workpiece, the second section being different than the first section.

36. The method of claim 29 wherein:
irradiating the workpiece with the first wavelength comprises impinging a first laser beam upon a first section of the workpiece; and
irradiating the workpiece with the second wavelength comprise impinging a second laser beam upon a second section of the workpiece, the second section at least partially overlapping the first section.

37. The method of claim 29 wherein:
irradiating the workpiece with the first wavelength comprises impinging a first laser beam with a first diameter upon the workpiece; and
irradiating the workpiece with the second wavelength comprise impinging a second laser beam with a second diameter upon the workpiece, the second diameter being different than the first diameter.

38. The method of claim 29 wherein:
irradiating the workpiece with the first wavelength comprises impinging a first laser beam with a first diameter upon the workpiece; and
irradiating the workpiece with the second wavelength comprise impinging a second laser beam with a second diameter upon the workpiece, the second diameter being at least approximately the same as the first diameter.

39. A non-contact method of assessing a doped structure in a semiconductor workpiece, comprising:
irradiating a portion of a semiconductor workpiece;
measuring photoluminescence from the irradiated portion of the semiconductor workpiece; and
determining a status of the crystal structure in the irradiated portion of the semiconductor workpiece based on the measured photoluminescence.

40. The method of claim 39, further comprising annealing the semiconductor workpiece before irradiating the workpiece.

41. The method of claim 39, further comprising annealing the semiconductor workpiece for a period of time based on the determined status of the crystal structure.

42. An apparatus for assessing a doped structure in a semiconductor workpiece, the apparatus comprising:
a laser configured to direct a laser beam toward a semiconductor workpiece;
a detector configured to measure photoluminescence from the semiconductor workpiece; and
a controller operably coupled to the detector, the controller having a computer-readable medium containing instructions to perform a method comprising
directing the laser beam toward a portion of the semiconductor workpiece;
measuring photoluminescence from the semiconductor workpiece; and
determining a physical property of a doped structure in the semiconductor workpiece based on the measured photoluminescence.

43. The apparatus of claim 42 wherein:
the instructions for directing the laser beam comprise (a) impinging the laser beam upon a first section of the portion of the workpiece, and (b) impinging the laser beam upon a second section of the portion of the workpiece, the second section being different than the first section;
the instructions for measuring photoluminescence from the semiconductor workpiece comprise (a) ascertaining a first value of photoluminescence resulting from impinging the laser beam upon the first section of the workpiece, and (b) ascertaining a second value of photoluminescence resulting from impinging the laser beam upon the second section of the workpiece; and
the instructions for determining the physical property of the doped structure comprise estimating a dose and an implant energy of a dopant based on the first and second values of photoluminescence.

44. The apparatus of claim 42 wherein the instructions for determining the physical property of the doped structure comprise calculating a dose and an implant energy based on a predetermined relationship between (a) photoluminescence and (b) dose and implant energy.

45. The apparatus of claim 42 wherein the computer-readable medium further contains instructions to compare the determined physical property of the doped structure with a predetermined range of acceptable physical property values for a specific dopant.

46. The apparatus of claim 42 wherein:
the instructions for directing the laser beam toward the semiconductor workpiece comprise impinging the laser beam upon a plurality of sections of the portion of the workpiece;
the instructions for measuring photoluminescence from the semiconductor workpiece comprise (a) ascertaining values of photoluminescence resulting from impinging the laser beam upon the sections of the workpiece, and (b) averaging at least some of the values of photoluminescence; and
the instructions for determining the physical property of the doped structure comprise calculating a dose and an implant energy based on the average of the at least some of the values of photoluminescence.

47. An apparatus for assessing a doped structure in a semiconductor workpiece, the apparatus comprising:
means for measuring photoluminescence from a portion of a semiconductor workpiece having an implanted constituent; and
means for estimating a dose and an implant energy of the implanted constituent based on a predetermined relationship between (a) photoluminescence and (b) dose and implant energy.

48. An apparatus for assessing a doped structure in a semiconductor workpiece, the apparatus comprising:
a detector configured to measure photoluminescence from a semiconductor workpiece; and
a controller operably coupled to the detector, the controller having a computer-readable medium containing instructions to perform a method comprising
measuring photoluminescence from a portion of the semiconductor workpiece; and
comparing the measured photoluminescence to a predetermined range of photoluminescence values that correspond to acceptable dose and implant energy values for a specific dopant.

49. The apparatus of claim 48 wherein the computer-readable medium further contains instructions to determine the dose and implant energy of the dopant based on a predetermined relationship between (a) photoluminescence and (b) dose and implant energy.

50. The apparatus of claim 48 wherein the computer-readable medium further contains instructions to direct a laser beam toward a portion of the semiconductor workpiece to effect the photoluminescence.

51. An apparatus for assessing a doped structure in a semiconductor workpiece, the apparatus comprising:
a laser configured to direct a laser beam toward a semiconductor workpiece;
a detector configured to measure photoluminescence from the semiconductor workpiece; and
a controller operably coupled to the detector, the controller having a computer-readable medium containing instructions to perform a method comprising
irradiating a portion of the semiconductor workpiece with radiation at a first wavelength;
measuring photoluminescence from the semiconductor workpiece resulting from the radiation at the first wavelength;
irradiating the portion of the semiconductor workpiece with radiation at a second wavelength, the second wavelength being different than the first wavelength;
measuring photoluminescence from the semiconductor workpiece resulting from the radiation at the second wavelength; and
calculating a physical property of a doped structure in the semiconductor workpiece based on the photoluminescence resulting from the radiation at the first wavelength and the photoluminescence resulting from the radiation at the second wavelength.

52. The apparatus of claim 51 wherein the instructions for calculating the physical property comprise determining a dose and/or implant energy of a constituent based on a predetermined relationship between (a) photoluminescence and (b) dose and implant energy.
